(19) United States
(12) Patent Application Publication
(10) Pub. No.: US 2009/0182679 A1
(43) Pub. Date: Jul. 16, 2009

(54) RIGHTS ESTABLISHING SYSTEM AND METHOD

(75) Inventor: Robert J. HARRINGTON, Framingham, MA (US)

Correspondence Address: FOLEY & LARDNER LLP, 111 HUNTINGTON AVENUE, 26TH FLOOR, BOSTON, MA, 02199-7610, US

(73) Assignee: OPTNOW Real Estate Corporation

(21) Appl. No.: 12/210,903

(22) Filed: Sep. 15, 2008

Related U.S. Application Data
(63) Continuation-in-part of application No. 11/052,146, filed on Feb. 7, 2005, now Pat. No. 7,440,926.
(60) Provisional application No. 60/542,513, filed on Feb. 6, 2004.

(51) Int. Cl. G06Q 30/00

(52) U.S. Cl. 705/80

(57) ABSTRACT

A system and method for providing a present consideration to a consumer and coincidentally establishing a future right for a holder to offer or to provide, at the holder's option goods or services in response to a trigger event

### CROSS REFERENCES TO RELATED APPLICATIONS

This application is a continuation-in part of U.S. patent application Ser. No. 11/052,146, entitled RIGHTS ESTABLISHING SYSTEM AND METHOD filed Feb. 7, 2005 which in turn claims the benefit of priority under 35 U.S.C §l 19(e) from U.S. provisional patent application Ser. No. 60/542,5137 entitled RIGHTS ESTABLISHING SYSTEM AND METHOD, filed Feb. 6, 2004 and claims the benefit of priority under 35 U.S.C. § 120 from U.S. non-provisional patent application Ser. No. 10/162,288, entitled METHOD AND SYSTEM FOR ESTABLISHING RIGHTS ASSOCIATED WITH PROPERTY TRANSACTIONS, filed Jun. 4, 2002, Each of the foregoing applications is hereby incorporated by reference in its entirety.

### FIELD OF THE INVENTION

The inventive concepts generally relate to the field of future interests, and more specifically to associating options and rights with future transactions.

### BACKGROUND

Historically, providers of products and services have provided those products or services in response to receipt of consideration from a consumer or client of those products or services. This relationship between the consumer and the provider took, whether explicit or implicit, the form of a contract where the provider received consideration in the form of a payment and the consumer received the products or services. In some instances performance by either party might not occur exactly at the time of contract formation. As one example, a consumer could enter into a brokerage (or listing) agreement having a promise to pay a real estate broker for its brokerage services at the closing of the sale of the subject real estate. In such a case, the contract is formed, but payment to the broker is delayed until after the broker completes performance of his or her services. In other cases, the provider performs and the consumer pays over time. For example, in a lending transaction a mortgage broker provides a loan and the borrower (i.e., consumer) pays it back with interest over time. In this case completion of payment to lender may take 30 years—so completion of the consumers obligations is accomplished long after contract formation or the related real estate transaction. These types of transactions are well known—and many examples exist.

There are other types of transactions where a consumer can purchase an option or a right of first refusal for goods or services. For example, a consumer can purchase a right of first refusal for the option to buy a product if and when it becomes available. Thus, the consumer can purchase a right to obtain a product in the future. As another example, in sports many professional athletes' contracts have options for additional years that are typically exercisable at the teams' options. In this case the team is the consumer of services and the athlete is the service provider.

In contrast, to date, situations where a provider of goods or services procures a right or option to be the future provider of goods or services is not generally done or to be a future bidder for such goods or services. There are situations where providers offer coupons that are redeemable in the future for goods or services offered by that provider, but in those cases the provider does not obtain a right to provide the future services or to bid on the opportunity to do so. The coupons are an attempt to entice the consumer to choose the provider, with no obligation on the part of the consumer to do so.

### SUMMARY OF THE INVENTION

In one aspect, a method is disclosed of obtaining a future right comprising one or more steps carried out by a computer The method comprises the steps of identifying a consumer and a holder; generating an opt-contract establishing consideration to the consumer and establishing a future right option in the holder, wherein the future right is a right to offer or to provide to the consumer a defined set of goods or services in response to a trigger event. In response to the trigger event, said holder, at its option, offering or providing the set of goods or services.

In one aspect a method is disclosed of attracting and retaining agency representatives for an agency provider comprising one or more steps carried out by a computer, said method comprising the steps of defining a set of consumers having a relationship to an agency representative; providing a present consideration to the set of consumers and coincidentally establishing a future right for the agency provider to offer or provide, at the agency provider's option a defined set of goods or services in response to a trigger event; monitoring for an occurrence of said trigger event; and in response to the trigger event, said provider providing, offering to provide or opting not to provide or not to offer to provide the set of goods or services.

In one aspect, and opt-contract system is disclosed comprising a computer program code executable by at least one processor. The computer program code includes logic comprising the steps of identifying a consumer and a holder, generating an opt-contract establishing consideration to the consumer and coincidentally establishing a future right option in the holder, wherein the future right is a right to offer or provide to the consumer a defined set of goods or services in response to a trigger event, and in response to the trigger event, said holder, at its option, offering or providing the set of goods or services.

In one aspect, an opt-contract system is disclosed comprising a database including data identifying a consumer and a holder, an opt-contract module configured for generating an opt-contract establishing consideration to the consumer and coincidentally establishing a future right option in the holder, wherein the future right is a right to offer or provide to the consumer a defined set of goods or services in response to a trigger event; and a trigger module configured for prompting the holder, at its option and in response to the trigger event, offering or providing the set of goods or services.

In one aspect, an opt-contract registry system is disclosed comprising at least one registry computer system comprising an interface for facilitating communication with one or more external computer systems via a network, at least one database coupled to the registry computer system and comprising a set of opt-contract data identifying) for each of a plurality of opt-contracts, at least one consumer, at least one consideration to the at least one consumer, at least one holder, and a set of future right options for the at least one holder related to the at least one consumer, wherein each future right is a right for the at least one holder to offer or to provide to the at least one consumer, at the at least one holder's option, a defined set of goods or services in response to at least one trigger event, and a trigger module configured for monitoring a set of external systems and generating a future right prompt in response to detection of the at least one trigger event.

In one aspect, a method is disclosed including: identifying a first party and a second party; establishing consideration to the first party; and generating an opt-contract establishing a conditional future right option in the second party. The future right is an option to offer or to provide to the first party with a defined set of goods or services in response to a trigger event. At least a portion of one or more of the above steps is carried out by a computer.

Some embodiments include monitoring for an occurrence of the trigger event.

In some embodiments, the establishing consideration is performed coincidentally with the generating an opt contract. In some embodiments, the establishing consideration to the first party includes establishing a promise by the second party to transfer value to the first party. In some embodiments, the promise by the second party to transfer value to the first party is a conditional promise to transfer value in response to the trigger event.

In some embodiments, the establishing consideration to the first party includes establishing a promise by the second party to transfer value to a third party on behalf of the first party.

In some embodiments, the third party is a charitable organization and the transfer of value includes a donation to the charitable organization.

In some embodiments, the establishing consideration includes transferring value from the second party to the first party prior to the trigger event.

In some embodiments, the establishing consideration includes transferring value from the second party to the first party subsequent to or coincidentally with the trigger event.

In some embodiments, the conditional future right option to offer or to provide to the first party with a defined set of goods or services in response to a trigger event is a transferable right. Some embodiments include transferring the conditional future right option from the second party to a third party in return for valuable consideration. Some embodiments include, prior to transferring the conditional future right, calculating the present value of the conditional future right.

In some embodiments, the conditional future right option to offer or to provide to the first party with a defined set of goods or services is related to a property, and the right runs with the property. That is, in the event that the first party transfers rights in the property (e.g. sells the property) to a third party, the second party retains a conditional future right option to offer or to provide to the third party the defined set of goods or services.

In some embodiments, the conditional future right option in the second party includes a right to engage a third party to offer or to provide to the first party with a defined set of goods or services in response to a trigger event.

In some embodiments, the trigger event includes the identification by the first party of a property of interest, and the future right is an option to offer or to provide to the first party with a defined set of goods or services related to the property of interest.

In some embodiments, the defined set of goods or services related to the property of interest include services related to the acquisition of rights related to at least of portion of property of interest. In some embodiments, the acquisition of rights related to at least of portion of property of interest includes an acquisition of rights by the first party In some embodiments, the acquisition of rights related to at least of portion of property of interest includes an acquisition of rights by a third party.

Some embodiments include in response to the trigger event, acquiring information related to an offer by a third party to provide goods and services to the first party; and determining, based on the information related to the offer by the third party, to exercise the second party's option to offer or to provide to the first party with the defined set of goods or services.

In some embodiments, the information related to the offer by the third party includes a cost information, and the determining, based on the information related to the offer by the third party, to exercise the second party's option to offer or to provide to the first party with the defined set of goods or services includes comparing the cost information to a threshold value.

In some embodiments, the option to offer or to provide to the first party with a defined set of goods or services in response to a trigger event includes a right of first refusal.

In some embodiments, the trigger event is related to a change in an available interest rate. In some embodiments, the interest rate is related to a publicized interest rate. In some embodiments, the first part is subject to a loan with a corresponding loan interest rate, and the occurrence of the trigger event is based on a change in the relationship between the loan interest rate and the available interest rate. In some embodiments, the available interest rate is related to at least one chosen from the list of. the U.S. Prime Rate, the London Interbank Offered Rate, Mumbai Inter-Bank Offer Rate, Tokyo Interbank Offered Rate, Euro Interbank Offered Rate, a U.S. Treasury rate.

In some embodiments, the trigger event is related to a change in a currency exchange rate.

In some embodiments, the defined sets of goods and services are related to a property. In some embodiments, the property includes tangible property. In some embodiments, the property includes real property. In some embodiments, the property includes intangible property. In some embodiments, the property is at least partially controlled by the first party

In one aspect a method is disclosed including the steps of, generating multiple opt-contracts for a holder; determining information indicative of a characteristic of each of the opt contracts; forming one or more bundles of opt-contracts from the multiple opt-contracts based on the information indicative of the characteristic of each of the opt contracts; selling one or more of the bundles to a buyer party. Generating each opt-contract includes: identifying a first party establishing consideration to the first party; and generating an opt-contract establishing a conditional, transferable, future right option in the holder where the future right is an option to offer or to provide to the first party with a defined set of goods or services in response to a trigger event. In some embodiments, the forming one or more bundles of opt-contracts from the multiple opt-contracts may include forming bundles comprising fractions of or partial rights to one or more opt-contracts.

In some embodiments, determining information indicative of a characteristic of each of the opt contracts includes determining information indicative of the value of one or more of the opt contracts.

In some embodiments, determining information indicative of a characteristic of each of the opt contracts includes determining information indicative of economic risk associated with one or more of the multiple opt-contracts.

In some embodiments, the forming one or more bundles includes forming one or more bundles of opt-contracts from the multiple opt-contracts based on information indicative of the value of one or more the multiple opt-contracts and on the information indicative of economic risk associated with one or more of the multiple opt-contracts.

Some embodiments include, for at least one of the multiple opt contracts, monitoring for the occurrence of the trigger event.

In some embodiments, for at least one of the multiple op-contracts, the goods and services are goods and services related to a property. In some embodiments, the property includes tangible property. In some embodiments, the property includes real property. In some embodiments, the property includes intangible property. In some embodiments, the property is at least partially controlled by the first party.

In one aspect, a system is disclosed including one or more computer modules configured to: identify a first party and a second party; establish consideration to the first party; and generate an opt-contract establishing a conditional future right option in the second party. The future right is an option to offer or to provide to the first party with a defined set of goods or services in response to a trigger event.

In one aspect, a system is disclosed including one ore more computer modules configured to: generate multiple opt-contracts for a holder; determine information indicative of a characteristic of each of the opt contracts; form one or more bundles of opt-contracts from the multiple opt-contracts based on the information indicative of the characteristic of each of the opt contracts; and facilitate sale of one or more of the bundles to a buyer party. Generating each opt-contract includes: identifying a first party establishing consideration to the first party; and generating an opt-contract establishing a conditional, transferable, future right option in the holder where the future right is an option to offer or to provide to the first party with a defined set of goods or services in response to a trigger event.

In another aspect, a method which includes the following steps: identifying a first party and a second party; establishing consideration to the first party; and generating an opt-contract establishing a conditional future right option in the second party where the future right is an option to contact the first party in response to a trigger event. At least a portion of one or more of the above steps is carried out by a computer. Some embodiments include monitoring for an occurrence of the trigger event.

In some embodiments, the option to contact first party includes the option to allow a third party to contact the first party.

Some embodiments further include: generating a list of parties which may not be contacted by the second party; and in response to the trigger event, at the second party's option: exempting the first party from said list. In some embodiments, generating the list of parties may includes obtaining “do not call” information from a publicly available or privately available source (e.g the so-called federal Do Not Call List, or other sources). In some embodiments, exempting the first party from said list may include permitting a third party to contact the first party.

In some embodiments, the option to contact the first party is an option to contact the first party during a defined period of time.

In some embodiments, the option to contact the first party in response to the trigger event includes an option to offer goods or services.

In some embodiments, the option to contact the first party in response to the trigger event comprises an option to contact the first party over a communication channel chosen from the list consisting of: postal mail, telephone, facsimile, e-mail, electronic messaging, text messaging, videoconference, and personal visitation. Some embodiments include acquiring contact information from the first party.

In another aspect, a system is disclosed including one or more computer modules configured to: identify a first party and a second party; establish consideration to the first party; and generate an opt-contract establishing a conditional future right option in the second party where the future right is an option to contact the first party in response to a trigger event.

In another aspect, method is disclosed including the steps of generating multiple opt-contracts for a holder, where generating each opt-contract comprises: identifying a first party and a second party; establishing consideration to the first party; and generating an opt-contract establishing a conditional future right option in the second party. The future right is an option to contact the first party in response to a trigger event; determining information indicative of a characteristic of each of the opt contracts The method also includes: forming one or more bundles of opt-contracts from the multiple opt-contracts based on the information indicative of the characteristic of each of the opt contracts; and selling one or more of the bundles to a buyer party.

In some embodiments, determining information indicative of a characteristic of each of the opt contracts comprises determining information indicative of the value of one or more of the opt contracts.

It is to be understood that, in various embodiments of the techniques and systems described above, the right of the second party to offer or provide goods and services or to contact the first party may include the right to engage or allow a third party to offer or provide the goods and services and/or contact the first party.

Various embodiments may include any of the above described features, either alone or in any combination.

As used herein, the term “party” is to be understood to refer to one or more legal entities, The one or more legal entities may include, for example, natural persons, corporations, trusts, foundations, partnerships, charitable organization, clubs municipality, school, school district, government or government board, agency or entity, or any other entity—there are no inherent limitations on the type of entity.

### BRIEF DESCRIPTION OF THE DRAWINGS

The drawing figures depict embodiments by way of example, not by way of limitations. In the figures, like reference numerals refer to the same or similar elements.

FIG, 1 is a flowchart showing a method in accordance with the present invention.

FIGS. 2A-2E are representative relationships in accordance with the present invention.

FIGS. 3A, 3B and 4 are representative architectures for implementing the method of FIG. 1 and the relationships of FIGS. 2A-2E.

FIG. 5 illustrates a trigger event monitor module.

FIG. 6 is a flowchart showing the operation of an exemplary trigger event monitor module.

FIGS. 7A-7E illustrate exemplary payment schemes for use with the method shown in FIG. 1.

FIG. 8 is a flowchart showing a method of bundling opt-contract future rights.

FIG. 8A illustrates an opt-contract future right bundling scheme.

### DETAILED DESCRIPTION

At a general levels provided is a system and method for securing or obtaining a right to participate in a future transaction, in exchange for established consideration—which takes the form of an “opt-contract”. The right to participate in a future transaction is referred to as a 15 “future interest” or “future right” in the future transaction, i.e., in a transaction that is to occur sometime after the consideration is established. Thus, there is a time period that exists between the establishment of consideration and the future transaction. That time period may be fixed or open ended. When the time period is open ended it may be that it only becomes finally determined upon the occurrence of a predetermined event, e.g., when the party receiving the consideration applies for credit, seeks to buy, sell, lease or rent real estate, and so on. As a general precept, the holder is typically a provider of goods or services and the party that receives the preset consideration is a “consumer”, or potential future consumer, of those products or services. The consumer could also be referred to as a “client”, or potential future client, of those products or services The future right could run with a consumer or with property.

In certain embodiments, given that the consumer and holder have established a “business relationship”, the holder could receive a right to permit communication between parties, where other entities may be prevented from such communication—e.g., the consumer opting out of a “do not call list” with respect to the holder. As an example if the consumer were looking for a new long distance carrier. The consumer could get $50 and allow itself to be added to a list of consumers that long distance carriers could call for a defined period of time—i.e., an “opt-on” to a list scenario. This of course could alternatively be implemented as an indefinite opt-off or for a period of time after which the names of the consumers could, for example, be sold.

But opting could also be implemented with other types of listings or programs, i.e., where consumers could opt-on or opt-off such lists. An example would be in the context of MLS (Multiple Listing System) listings. In one implementation, real estate firms could show the MLS listings on their own website, but they could also chose to opt-off the list of firms permitted to show the MLS listing. In such a case, the firm that opted-off could not show the MLS listing of other firms, but that opted-off firm could also be excluded the MLS listings shown by such other firms. Accordingly, people could be paid to change their preference with regard to inclusion on such a type of list.

In general, in various such embodiments, the opt contract may provide the opt-contact holder a optional right to contact and/or otherwise communicate (or allow a third party to contact/communicate) with a consumer party in response to a trigger event. The contact may be informational or may include advertisement an offer to provide goods or services other types of solicitations a survey etc. In some embodiments the optional right to communicate may be combined with or related to an optional right to offer and provide goods and services in response to the same or an additional trigger event.

The optional right to contact may include a right to communicate through one or more suitable communication channels such as mail, telephone facsimile-mail (e.g. SMTP messaging), text messaging (e.g. SMS messaging, or other instant messaging services), video conference (internet based or otherwise), in person meetings, etc.

For example, in some embodiments a consumer may enter into an opt contract with a holder party (e g. in return for a payment or other benefit, promise of a future payment/benefit). The agreement provides that if the consumer indicates interest in the holder party (or one or more third parties), for example, by visiting the party's website, telephoning the party, or takes other specified action, such as listing a home for sale, a trigger event is deemed to have occurred. In response to the trigger the party obtains an option to contact the consumer, or to allow one or more third parties to contact the consumer. For example, the party may be optionally allowed to contact the consumer on his/or her cell phone, during a defined period (e.g. 30 days) or open ended period (e.g. until the consumer indicates a desire to no longer be contacted). In some embodiments the consumer may receive benefits (payment, gifts, coupons, special offers, frequent flier miles) conditioned on factors such as the holder's decision to contact the consumer, the length or frequency of holder/consumer contact, consumer willingness to participate in activities such as surveys or focus groups, etc.

In some embodiments, the trigger even may occur when the consumer requests contact from the opt contract holder and/or third parties. For example, the opt contract holder may maintain a web site listing a number of third parties (e.g. various services providers related to real estate transactions). The consumer may visit the web site and select one or more third parties or interest. The opt contract holder may then allow contact and communication between the selected third parties and the consumer. In some embodiments, the consumer may select groups or categories of parties which may be allowed to contact them (e.g. plumbers, window replacement service providers, cell phone service providers, etc.). In various cases, the consumer may or may not be aware of the specific identities of the parties in a given category. For example, a consumer may select to allow contact by plumbers, but may not be provided with a list of the specific plumbers. The opt-contract holder could allow contact between the consumer and a group of plumbers with which the holder has a preexisting relationship, and/or seek out plumbers to place into contact with the consumer (e.g. for a “finders” type fee). The forgoing techniques may incorporate any of the various features described herein.

FIG. 1 is a flowchart 100 depicting a method in accordance with the present invention for a provider (or holder) to obtain a future right in return for a present consideration given to a consumer (note that the consideration need not be a direct payment, but may be established by a promise, e.g. of future payment, future action, etc.). In step 102, an offer is made by a provider to a consumer. The offer includes, identification of the present consideration to be given to the consumer and the future right to be given to the provider. The offer also includes identification of a condition to be satisfied or “trigger” of the future right. In step 104, the consumer accepts the offer and the opt-contract is formed. While it is not shown, negotiation between the consumer and provider may take place prior to acceptance of the offer. Upon acceptance, the consumer receives the present consideration and the provider becomes the holder of the future right. Thus the future right is then owned or vested in the holder, and may be transferrable.

In step 106, the holder monitors for the presence of the trigger event. The trigger event could be, for example, an event such as an act by the consumer related to or in furtherance of buying or selling the goods or services for which the holder has a right, or at least related thereto. For example, the consumer's application for a mortgage could trigger the holder's right to be a listing broker of the consumer's present real estate or a buyer's broker for the real estate being purchased by the consumer. It could, perhaps, trigger the right of a holder to provide a home inspection, title work or other related legal service or other related real estate transaction services. The trigger event could be expiration of a time period, e.g., if the provider paints houses, after five years the provider could have a right to bid on repainting the consumer's house, with a right to match a more competitive competing offer. Other types of triggers could be defined—depending on the products and services and the creativity and needs of the consumer and provider. In many instances it is foreseeable that the future right allows the consumer to choose a different provider, so long as the holder has been given the opportunity to meet the terms offered by the different provider. Preferably, it would be incumbent on the consumer to use the holder if it did meet, or substantially meet, the terms offered by the different provider. This removes the risk of price gouging by the holder for performance in accordance with the future right.

In any of the various embodiments herein, the opt-contract could provide rights to the holder multiple times. Thus, if the consumer refuses the 1st time, the holder has subsequent opportunities to provide the goods or services. An opt-contract for the holder to provide snowplowing is one representative example. In such a case, the holder has 1st right of refusal for a snowplowing contract. If someone else bids very low, the holder can choose not to take the job at that low bid. Next year, or next snowstorm, the holder has the same option. Therefore, refusal in one instance need not terminate any future rights. The opt-contract could state a particular number of times the holder will be given the options, or it could be set based on a period of time.

In step 108, unless and until the triggering event is detected, the monitoring of step 106 continues. If, in step 108, the triggering event has been detected the method continues to step 110. In step 110, the holder has the opportunity to exercise his future right. Note that preferably the holder has no obligation to provide anything at this point in time, but rather has the option to do so at its discretion in the future. As a result, in step 110 the holder may choose (or “opt”) not to exercise its right. If the holder does choose to exercise its right then there are a variety of scenarios that can take place, depending on the definition of the future right in step 104. Exercise of the holder's option may mean that the holder has the absolute right to provide the goods or services. In most cases, however, it is envisioned that the holder will have a right to bid on the opportunity to provide the goods or services. In such a case, as mentioned above, the consumer may be obligated to select the holder over competing bidders if the holder's terms are more favorable than or at least as favorable as all other qualified bidders. In some cases, the consumer may be obligated to select the holder, so long as the holder's price is not greater than some threshold value above the price of other qualified bidders. For example, as long as the holder's cost or schedule is not more than 10% of the lowest qualified bidder, then the consumer is obligated to select the holder. In any of the above scenarios, there could be a buyout option where the consumer (or its preferred provider) can buyout the holder of its option for a fee, thereby eliminating any obligation of the consumer to select the holder.

As discussed previously a broker (as the holder) and consumer can take any of a variety of forms. The consumer can be an individual, person, trust, corporation, partnership, charitable organization, club, municipality, school, school district, government or government board, agency or entity, or any other entity—there are no inherent limitations on the type of entity. The consumer could also be a provider of goods or services in other contexts. The consumer may take the role of at least one of an owner (whole or partial), a prospective owner, a seller, or a prospective seller, licensee or licensor of tangible or intangible property such as real estate, vehicles (cars, trucks, boats, construction vehicles, etc.), art, stock or other securities, intellectual property, jewelry, furniture, clothing, natural resources, equipment, or food—as just a few examples. The consumer could also be a present or future consumer of services, such as lending (e.g., mortgage, auto loan, student loan, etc.), real estate brokerage, improvement, maintenance, or construction, travel agency, financial planning, investment advising, medical treatment or counseling, education, legal, advertising, marketing, consulting, entertainment, therapeutic, spa, or grooming services. The holder may be a provider or a broker of any of the foregoing.

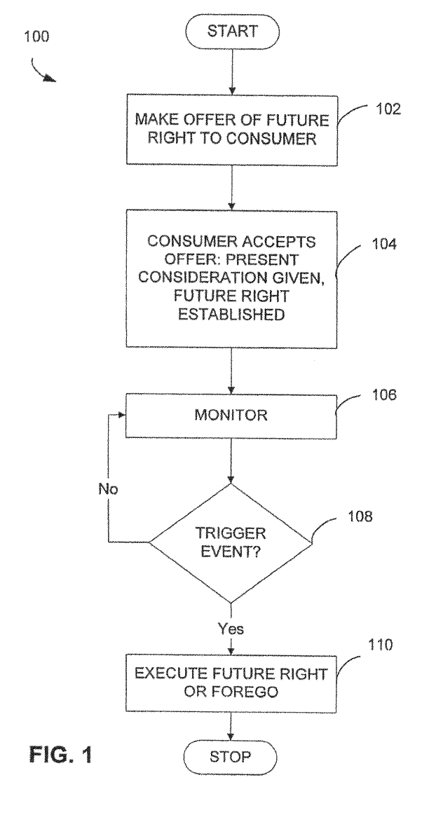

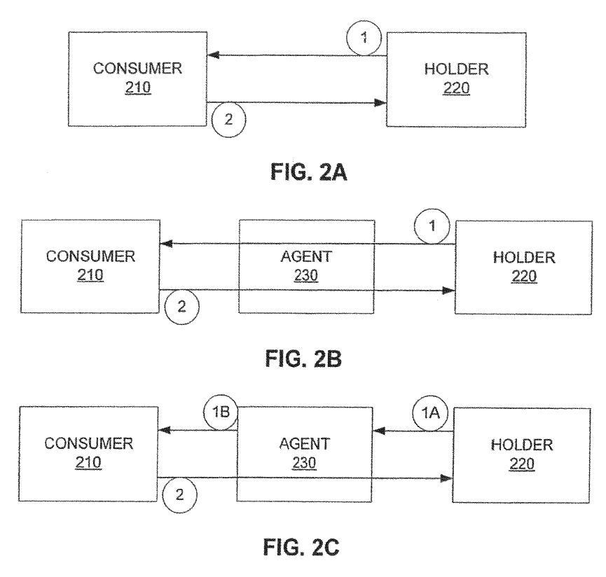

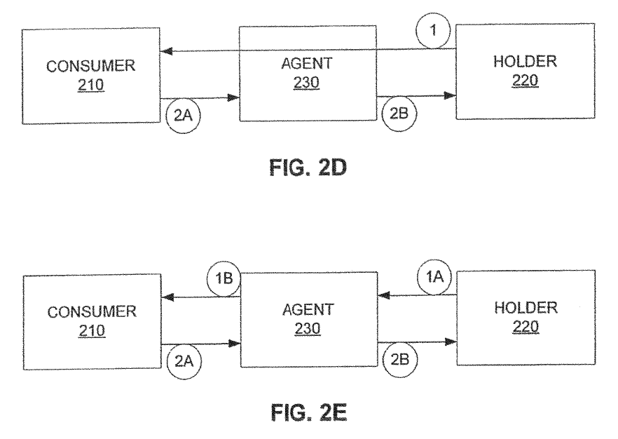

FIG. 2A through FIG. 2E show various types of possible relationships between a consumer and a holder, as illustrative examples. Other types of relationships may also be established, as will be appreciated by those skilled in the art—so long as consideration is given to the consumer and a future right goes to the holder. In any of the various embodiments, the holder could change multiple times, over the life of the opt-contract. For example, the holder could sell or assign its interest to another party, which in turn could sell or assign its interest to yet another party. Or the holder could be comprised of more than one party. In such cases the multiple parties could provide companion or related services, or disparate services. Also, as with holders, there could be multiple agents.

An opt-contract could include more than one good or service as its subject matter, e.g., real estate brokerage for buying and selling, renting, leasing, mortgage, refinance, moving, home inspection, or other home related (or unrelated) services and the trigger might be defined differently for different goods or service, or subsets thereof. Accordingly, each good or service, or subset thereof could be different as to first right, actual performance, and whether or not the first right or performance could be triggered multiple times. Goods or services could be defined specifically (e.g., plumbing services) or generally like all home maintenance services or home maintenance items, and so on. Such a structure could be referred to as “bundling”, where opt-contracts could be combined in any combination. In various embodiments, there could be multiple holders and/or agents for each type of good or service and or across several of the types of goods or services.

Additionally, in various embodiments, the consumer could be multiple consumers each having received consideration and each giving a future right. For example, a condo complex could be opted and all (or at least several) of the individual condo owners covered, where the future right could be an obligation that runs with the property or owner, or both. For example, the holder could agree to pay each owner $100 in exchange for the holder getting a future right with respect to each owner. In other cases the holder could agree to provide a service to the condo association as up-front consideration, and get a future right with respect to each owner. For instance, the holder could have all of the parking lots resurfaced, or the roofs re-shingled, or the common areas painted as consideration for the future right, for example, to provide mortgage, real estate brokerage, financial planning services, and tax preparation services to each condo owner.

As will be described in detail below, bundling techniques may also be used to produce instruments consisting of multiple opt contracts involving multiple consumers and/or holders for sale and/or trading.

FIG. 2A represents the simplest relationship between a consumer 210 and a holder 220. In this figure, arrow “1” represents the present consideration going to the consumer 210 and arrow “2” represents the future right going to the holder 220. In FIG. 2A there are no intermediate parties.

In FIG. 2B an “;agent” 230 is introduced as an intermediate party An agent may be or act as, for example, a broker or agent of the consumer 210 or a broker or agent of the holder 220 At a minimum, the agent is a party through which at least one of the present consideration 1 or future right 2 passes or is coordinated. In FIG. 2B the present consideration I passes from the holder 220 to the consumer 210 via the agent 230. And the future right 2 passes from the consumer 210 to the holder 220 through the agent 230.

In FIG, 2C a present consideration 1A flows from the holder 220 to the agent 230. The agent 230 may modify or substitute the present consideration IA and provide present consideration 1B to the consumer. Here future right 2 passes from the consumer 210 to the holder 220 via the agent 230, unaltered. FIG, 2D shows a situation similar to that of FIG, 2C, Here the present consideration 1 passes from the holder 220 to the consumer 210 via the agent 230, as in FIG. 2A But the future right 2A passes from the consumer 210 to the agent 230, where the agent may modify or substitute the future right 2A and provide future right 2B to the holder 220. FIG. 2E represents the case where the agent modifies or substitutes both of the present consideration and the future right.

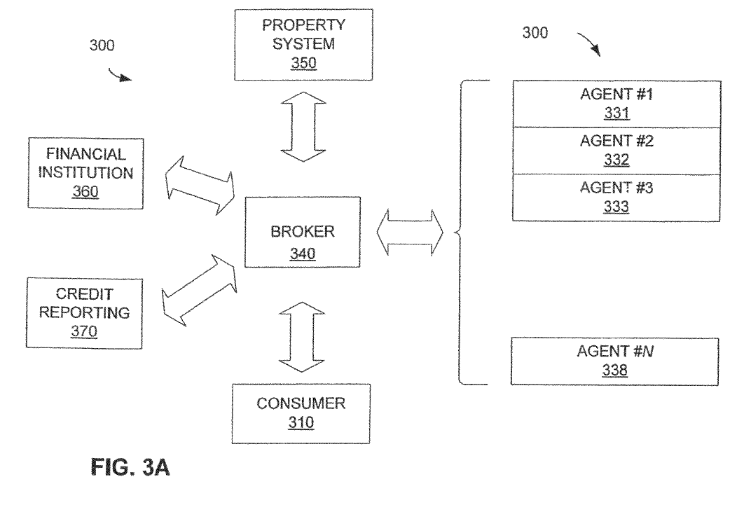

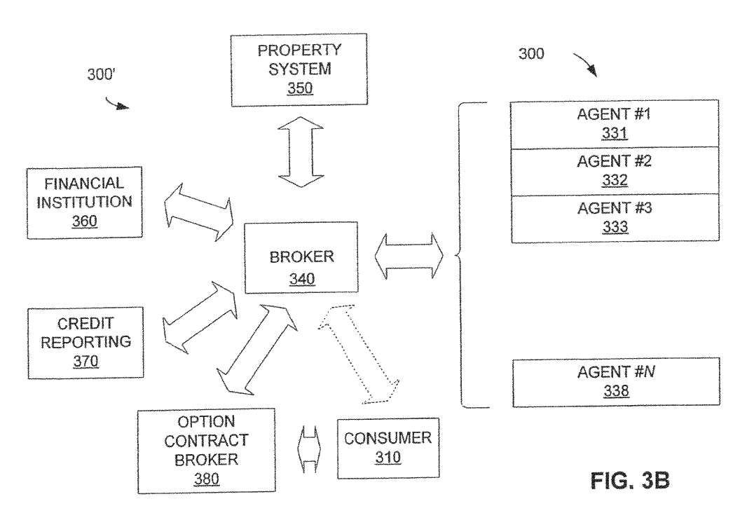

FIG. 3A and FIG. 3B represent embodiments in a real estate context that can take the general form of the relationships of FIG. 2A-FIG. 2E. FIG. 3A represents one possible embodiment 300 of the present invention, which allows a homeowner (i.e., consumer 310) to receive an payment in return for the homeowner (i.e., consumer) agreeing to use the services of a real estate broker (i.e., holder) or brokerage firm 340, or giving that broker a first right of refusal to list the property. Associated with the broker 340 may be a group of agents 331-338, from which the ultimate listing agent may be chosen to sell the homeowner's house, e.g., agent #1 331. For example, assume that a homeowner 310 is offered the opportunity to enter into an “option listing contract” or “opt-contract” concerning any future offering of the homeowner's house for sale, i.e., a contract for the future right for the broker 340 to list the house. If, for example, the present value of the homeowner's house is $166,000, the broker could, for example, offer the homeowner 0.10% of the house's present value as present consideration for signing the opt-contract, and thereby providing the broker 340 the future right or option to be the listing broker for the property. In this example, the 0.10% is $166 in present consideration.

As mentioned above, in some forms, the future right could be a right of first refusal provided to the broker. The broker's future right could be guaranteed or optional, as described above. The right of first refusal could be related to, and exercised in response to, the homeowner's notice to the broker of an intent to sell, buy, refinance, or take a loan against a property, depending on the type of broker and holder right. With the right of first refusal, the broker has the option of whether or not to provide services or to match an offer by a competing broker. For instance, if a homeowner (e.g., a seller) can get better terms from a competing broker, the broker holding the right of first refusal may have the option of matching the more favorable terms of the competing broker and providing the broker services. However, if the broker chooses not to match, then the broker may be required to forfeit claims to any future compensation related to the opt-contract.

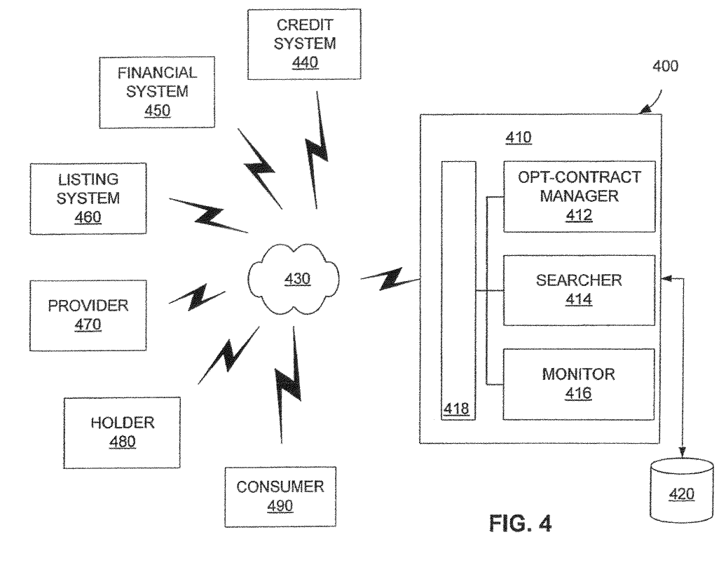

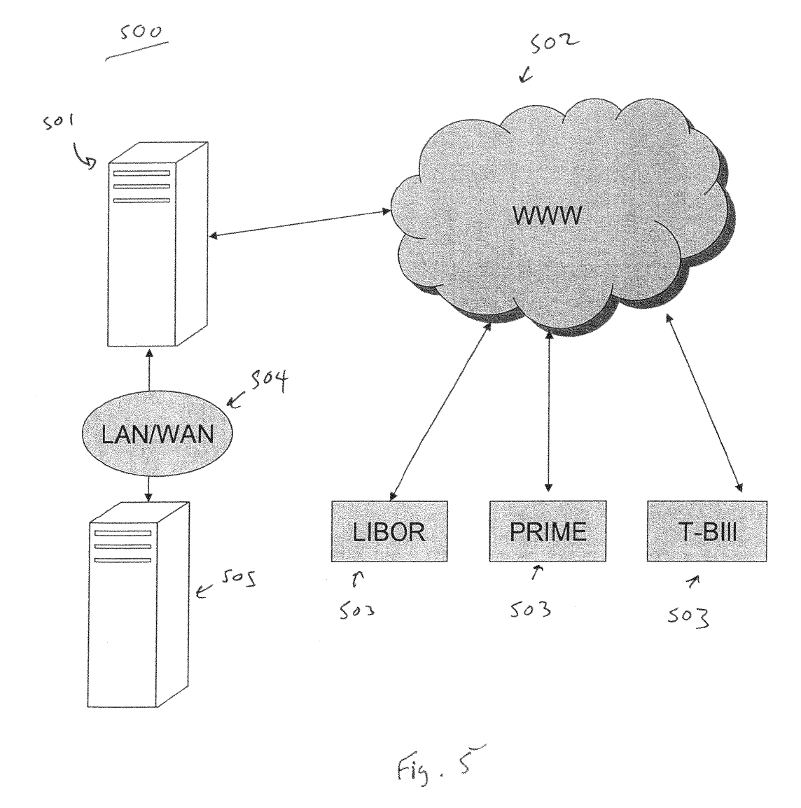

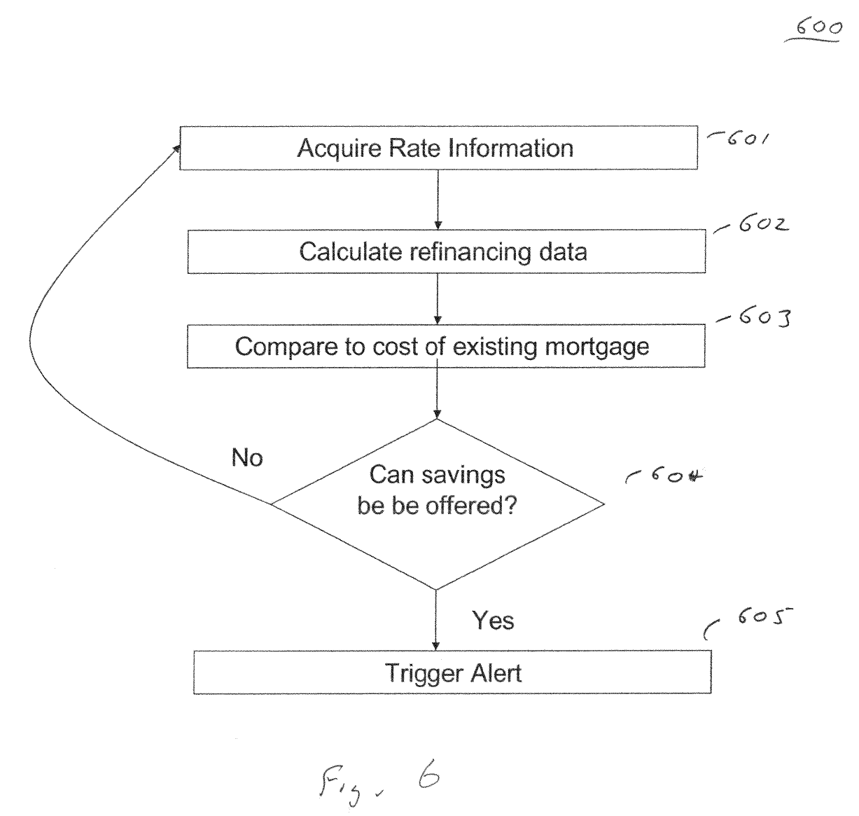

In the example above, assume that six years after the opt-contract, the homeowner 310 decides to list the house for sale. The homeowner 310 would then contact the original broker 340 (or the current owner of the opt-contract) and explain that it wants to list the house. Otherwise, the broker 340 could learn of the homeowner's intent to sell by some other means, e.g, reporting from a financial institution 360 or from a listing in a multi-listing service (MLS) system 350—if the homeowner 310 had failed to notify the broker 340 and listed the property through a different broker. Or the broker could learn from a credit reporting agency 370 of an inquiry related to obtaining the home owner a mortgage, such examples are discussed with respect to FIG. 4.

In one example, shown in diagram 300′ of FIG. 3B, assume there is a opt-contract broker 380 that holds the opt-contract (i.e., future right) and that the opt-contract broker then uses a real estate brokerage firm 340 (and listing agent 331) to actually perform the services when the homeowner is ready to sell. Thus the homeowner 310 and broker 340 have a relationship as a result of the opt-contract broker 380 (indicated by the dashed line arrow). Assuming that e.g., the total sales commission is 5.00% (i.e., 2.50% listing and 2.50% selling), 25% of the total sales commission goes to the opt-contract broker, of which 15% goes to the actual opt-contract broker and the remaining 11% goes to covers the money that was provided to the homeowner six years ago, and various overhead costs. For example, assume that the home was listed by the broker 340 and sold for $294,699. The buyer's broker gets 2.5% (i.e., $7,367) and the seller broker side gets the same 2.5% (i.e., $7,367). The seller broker's $7,367 fee could be divided up as follows, as discussed above:
1) Opt-contract Broker: 25% of 2.5%=$1,842
   a) Referral Fee (15 of the 25%)=$1,105
   b) Miscellaneous (10 of the 25%)=$737
2) Broker Split=$7,367−$1,842=$5,525
   a) Brokerage Office (30%)=$l,657
   b) Broker (70%)=$3,868

The Broker Split is the split between the broker 340 and the listing agent, e.g., agent #1 331.

In yet another embodiment, the homeowner gets, for example, 10 basis points (BPs) of the assessed value of the property and the broker 340 (or listing agent 331) gets 15% of the gross commission income (GCI) at sale. In some embodiments, the broker/agent get some money for getting or referring an opt-contract. In yet another form, the homeowner gets, for example, 10 BPs (the same as above), and the agent gets 5 BPs, and then only 10% of GCI out the back end, i.e., sale of the property. In other embodiments the BPs and percentages could be different, so maybe 10 BPs to both the homeowner and to the agent, but nothing out the back end.

As will be appreciated from FIGS. 2A-2E above, in various embodiments, the agent could advance the consideration for the holder. In such cases, the holder could pay the agent at some future point in time, e.g. when future right is exercised. If the holder advances some or all of the consideration, the holder could be entitled to collect interest or could be given some other type of consideration by the holder, e.g., some type of marketing, advertising or publicity. Various financial or other consideration schemes could be worked out between agents and holders, so long as the consumer gets consideration and the holder gets a future right.

FIG. 4 provides an embodiment of an architecture 400 that includes a registry that may be provided for listing or recording opt-contracts. In FIG. 4 a registry system 410 includes or provides access to one or more databases or database systems 420 within which opt-contracts are recorded using an opt-contract manager 412. Opt-contract manager 412 provides general administrative tasks related to the recording and maintenance of opt-contracts in database 420. The opt-contract system 410 may include a searcher module 414 that allows external parties to search database 420 via a network 430 (e.g., the Worldwide Web/ Internet). Such parties may include the holder 480 or consumer 490 that entered into an opt-contract. These parties may also record their opt-contracts with opt-contract system 410 over network 430. These external systems (e.g., 440, 450, 460, 470, 480, 490) may be configured with logic or program code that facilitates the foregoing access, and which may be configured for automated checking, querying, receiving or other communications of registry system 410 or other relevant systems.

A monitor module 416 may also be included and be configured to monitor for external events that trigger the holder's future right. Such events may be reported to monitor 416 of the opt-contract system 410 or determinable by the monitor 416 via access to external systems, such as a credit reporting system 440 that provides credit reports, a financial system 450 that lists applications for loans or credit, or a listing system 460 that lists property for sale or lease. In other instances, other providers 470 may also access the opt-contract system 410 to determine whether a future right with a holder 480 exists, before providing goods or services to consumer 490 that are the subject of an opt-contract with holder 480. Providers 470 may or may not be obligated to perform such a check.

In some embodiments the opt-contract system 410 may be configured to send notices to one or more of credit systems 440, financial systems 450, listing systems 460, providers 470, holders 480 or clients 490 of the recording, existence or removal of an opt-contract from database 430. In such a case, this could be done as part of a subscription by any of the foregoing to a service offered via the opt-contract system 410. In any of the foregoing embodiments the opt-contract system 410 may include an access control module 418, which selectively controls access to the opt-contract manager 412, searcher 414, monitor 416, and/or database 430. Depending on the embodiment, the access control module 418 could also include account management, rights management, firewall or other security functionality. In some embodiment, the opt-contract system 410 may charge a fee to perform searches or to record opt-contracts. In any of the foregoing embodiments, opt-contracts could be tracked by consumer (e.g., real estate property owner) or holder (e.g., real estate broker or agent). In any of the above cases, any of the external parties 440, 450, 460, 470, 480, or 490 may pull data from the database 430 to, for example, include opt-contract data in their own reports. For example, a credit reporting agency may pull opt-contract information from database 430 and include it within a consumer's credit report or in a standalone report. In another context, an external registry of deeds may access database 430 and record opt-contracts against related properties—or at least create a link or a reference between a property deed and a related opt-contract in database 430,

A secondary market may be created in which groups of opt-contracts are solicited by a first party (e.g., an independent contractor or realtor) and then sold to a second party (e.g. a real estate company). When selling these opt-contracts, the present value of these contracts (that statistically will mature over the course of years) is calculated, thus allowing the party who obtained the contracts (i.e., the first party) to get an immediate return on their contribution. This is similar to the manner in which a mortgage broker sells off mortgages to third parties based on the current value of the mortgage contract. However, for opt-contracts a different type of cash flow is realized by the buyer of the contract in that unlike mortgages in which each house generates a revenue stream every month, each opt-contract generates a single source of revenue when the homeowner in question sells their property. Where a secondary market is created, opt-contracts could be grouped and sold in bundles, or may serve as the underlying assets against which securities are offered—as an investment vehicle. Further examples of opt-contract bundling and resale are presented below.

Current mortgage companies (i.e., companies who own the existing mortgages on a home owned by a homeowner) may enter into an opt-contract with the homeowner that (in exchange for consideration being provided to the homeowner) provides the current mortgage company with the opportunity to match the terms of any future refinancing of the homeowner's mortgage. As the current mortgage company owns the current mortgage, there is an automatic trigger in this system since the homeowner that wants to refinance must call in to get a payoff amount for the mortgage. At this point, the mortgage company can determine if the homeowner entered into an opt-contract. Further, these opt-contracts may be entered into at the time of closing for any new mortgages, in that the current mortgage company may offer the new homeowner consideration in the form of a discount (e.g., on closing costs or interest rates) in return for the mortgage company having the right of first refusal in future refinancing. Of course, an opt-contract could be entered with respect to an existing mortgage, so long as consideration is given to the consumer and the future right is given to the holder (e.g. broker).

Here it could be said that the opt-contract is “added” to the mortgage, i.e., the subject matter of the future right is related to the existing mortgage.

An opt-contract may also be applied to consumer products, such as cellular telephones. For example, a cell phone user can be paid money up front on the premise that the cell phone user will contact the option listing broker (i.e., holder) when the cell phone user needs a new cell phone. If the holder is a cell phone service provider than the future right could be related to the cell phone user changing its service provider or its service plan. While the consumers entering into opt-contracts are described above as receiving a monetary payment, other forms of consideration are possible, such as gift certificates, discounts, coupons, frequent flyer miles, cell phones or services, for example.

While the illustrative holder discussed above has been primarily a real estate or mortgage broker, the holder could be any type of broker. For example, employment agents (or recruiters) are brokers, as they bring together buyers and sellers of labor. In such a context if the holder is the recruiter, the consumer could be the employer, worker, or both. There are many examples of brokers that arrange for the procurement, sale and distribution of products, whether between manufactures or producers and wholesalers and/or retailers and/or typical consumers or users. Of course the insurance industry uses insurance brokers to sell insurance to individuals and business entities. In such a case the insurance broker could hold a future right to offer insurance to either. In other cases the holder could be a retailer, manufacturer, or wholesaler of products. For example, if the holder were a retailer that sells home appliances, but not televisions. The retailer could enter an opt-contract where the future right is related to the consumer's future decision to purchase a television. The right could give the retailer the first right in the future to sell that consumer a television. Of course, this type of opt-contract would also work if the retailer did typically sell televisions. Or a store could enter an opt contract where it has a right if the consumer changes brands or simply desires to purchase for any reason. Additionally, an individual salesperson could be the holder or an agent, with 1st right on making the sale of a product to the consumer.

In some embodiments, an opt-contract holder may establish a future right to offer or provide goods and services related to property or class of property identified by the consumer. For example, the holder may serve the role of a “buyer's broker.” The holder establishes a future right to optionally facilitate the purchase of property in response to a trigger event. The trigger event occurs when the consumer identifies a property or class of property of interest. For example, the trigger event may occur when the consumer identifies a specific piece of real estate, a specific vehicle, a specific item of collectable art, a specific piece of intangible property (e.g. a patent) which he or she in interested in, for example, for possible acquisition In other cases, the trigger event may occur when the consumer identifies a class of properties of interest. For example, in some embodiments the trigger event may occur when the consumer identifies an interest in acquiring a home or a type of vehicle, but prior to the identification of a specific house or a specific vehicle.

In the example above, once the holder is notified of the occurrence of this event, the holder may then choose to act as a buyer's broker by, for example, contacting the owner of the identified property on the consumer's behalf, representing the consumer's interests in negotiating the purchase of the identified property, providing services related to the identified property (appraisal, inspection, legal or tax advice, etc.), providing a mortgage or other loan for the purchase of the property, etc.

Ship or transportation brokers keep informed of the movement of vessels, of cargo space available, and of shipping rates and sell this information to shippers and, potentially, to consumers of shipping services. Such brokers serve tramp carriers in the main, inasmuch as the larger shipping lines tend to have their own agents or brokers. Such brokers also serve as post agents, in which capacity they settle bills for stores and supplies, pay the wages of the crew, and negotiate insurance for the vessel and cargo. They may also arrange the sale of ships.

In organized markets, such as commodities and stock exchanges and bond markets, commission merchants and straight selling displace brokerage in large part, but between cities where there is not active exchange, brokers in grain and other commodities are active. As another example, particularly in the U.S., note brokers buy promissory notes and sell them to bank or other financial institutions. Traders in acceptances and foreign bills of exchange are known in the U.S. as acceptance dealers (i.e., brokers). Customs brokers though, are not actually brokers in the traditional sense, but they do act as agents for importers in estimating duties and clearing goods—so as a service provider can be a holder of a future right. As another example, a pawn broker is a private money lender. In many instances, on-line service providers act as brokers of goods or services, e.g., products on eBay or Amazon, travel on Orbitz and so on. Additionally, travel agents in a traditional sense are brokers of vacation packages, accommodations, transportation and other services, Energy, telecom, internet service providers, cable companies are all providers that can serve as agents or holders or both.

In some embodiments, the holder of the optional future right to offer or provide goods and services need not directly offer or provide the goods or services, but may instead engage a third party to do so. For example, consider a case where a holder enters into an opt-contract with a consumer establishing in the holder the future right to provide cleaning services when the consumer lists a home for sale. The opt-contract may provide that the future right holder may, upon executing the future right, engage a third part cleaning crew to provide the cleaning services. The holder may receive payment directly from the consumer for the cleaning services (and then may pay the third party cleaning crew from these or other funds). Alternatively, the holder may collect a fee from the third party cleaning crew (akin to a referral fee), while the consumer pays the third party cleaning crew directly for the cleaning services performed.

In another embodiment, the invention may comprise a method of attracting or retaining one or more agency representatives to a particular business agency where those agency representatives may otherwise come and go, taking customers with them. Such a method may comprise the signing of potential customers of that particular business agency, so as to utilize that particular business agency if any particular need arises to do business with that particular business agency—regardless of whether or not the agency representatives remain with the business agency. The method may also include providing the potential future customers with an incentive such as a present consideration, where those potential future customers sign an opt-contract securing a future right related to entering a future relationship with that particular business agency. As with embodiments above, these opt-contracts can be recorded. Also, as an example, the business agency can be a real estate agency and the agency representative can be a real estate broker. In another embodiment, the agency may be a stock brokerage agency and the agency representative of the stock brokerage is a stock broker. In yet another embodiment, the agency may be an auto dealership and the representative could be a sales person or dealer spokesman.

In insurance related embodiments, the holder may be insurance agencies or companies obtaining a future right related to providing homeowner, title, malpractice, automotive, personal, health or business related insurance. In a mortgage or financing embodiment, the holder may be financing agencies could be lenders offering new mortgages refinance opportunities home equity loans or lines of credit or loan for investment property, timeshares or second homes.

In yet other embodiments, moving or relocation companies could be the holder of a future right to provide moving or relocation services. In yet other embodiments, auto companies or dealers could be holders of a future right related to the sale or lease of new or used vehicles. In yet other embodiments, auction houses or auctioneers could be the holder of a future right related to providing auction services. In yet other embodiments, dealers of coins, automobiles, wine, art, jewelry or other collectibles could holder a future right related to selling such goods.

In yet other embodiment, a travel, cruise, airline or vacation agencies or outlets could hold future rights to provide their services. In construction suppliers of building materials could hold a future right related to providing such materials to construction companies. Similarly, auto part suppliers could hold future rights related to providing auto parts to mechanics and garages.

In yet another embodiment, a casket or headstone company could hold a future a future right related to providing such products to undertakers or funeral homes. In other embodiments, an agency could hold a future right related to providing tickets to sport, theater, concert or other entertainment events. With respect to the Internet, a provider may hold a future tight related to providing or offering for sale domain names.

In another embodiment, a credit card company could hold a future right related to providing or offering credit cards or accomplishing balance transfers. In yet another embodiment, a provider could hold a future right to performing fund raising on behalf of, for example, non-profits organizations.

In yet another embodiment, a holder could hold a future right related to offering or providing goods and services related to a virtual world or online community. Establishing the future right may involve a payment or promise of payment in virtual currency (e.g. the “linden dollar” in the well known Second Life virtual world).

As described with respect to FIG. 2A-FIG. 2E in any of the above embodiments an opt-contract agent may serve to obtain the holder right on behalf of the provider/ holder. For example, an insurance agent can act to obtain a future right on behalf of an insurance company. A mortgage broker can act to obtain a future right for the lender. A travel agent can serve to obtain a future right on behalf of an airline, cruise line, hotel chain, etc. But the agent need not have a common business area with the ultimate holder of the future right. For example, a bank or credit card company could offer a future right on behalf of a travel company, insurance company, auto company, or lender. In such a case, the credit card holder could, for example, receive a $100 credit toward its credit card balance or, for example, a check for $100 instantly negotiable in exchange for giving a future right for a lender to compete for the holder's next mortgage, product or service. Similarly, a utility company could serve as an agent for obtaining a future right for a credit card company to compete for the consumer's future credit card business. The present invention, therefore, could take any number of embodiments.

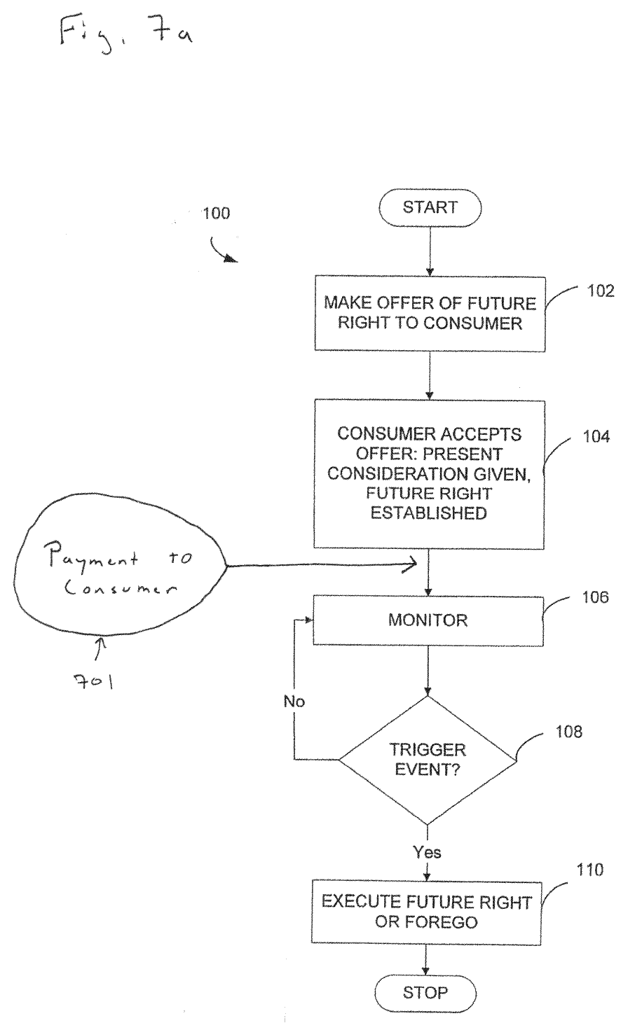

In various embodiments, the trigger event for an opt-contract may be related to an available interest rate. In such cases, monitoring for the occurrence of the trigger event may include monitoring publicly or privately available interest rate information sources. For example, referring to FIG. 5, exemplary monitor system 500 includes a monitor module 501 (e.g. implemented on a computer or computer system). Monitor module 501 is coupled via the internet 502 to publicly available interest rate information sources 503. For example, as shown, information sources 503 include information about the London Interbank Offered Rate (LIBOR), U.S. Prime Rate, and U.S. Treasury Bill (T-Bill) rates. Of course, in various embodiments, any number and type of information sources may be used, including, for example, sources related to the U.S. Federal Funds Rate, U.S. federal reserve Discount Rate, Mumbai Inter-Bank Offer Rate, Tokyo Interbank Offered Rate, Euro Interbank Offered Rate, other U.S. or Foreign Treasury rate, publicized rates by private lenders, etc.

Still referring to FIG. 5, monitor module 501 is also coupled, via private network 504, to private rate information source 505. Of course, any suitable communication link, e.g. an encrypted link over a public network, may be used. Private rate information source 505 nay be, for example, a proprietary database of available interest rates. Such rates may, in some embodiments, depend on information (e.g. credit rating information) about the consumer party, or a property related to the relevant opt contract. Such information may be obtained using, for example, techniques described above.

Monitor unit 501 analyzes information obtained from rate information sources 503 and 505 to determine if a trigger event has occurred. For example, monitor unit 501 may compare one or more available interest rates to a threshold value, and indicate the occurrence of a trigger event if one or more interest rates move above across the threshold value.

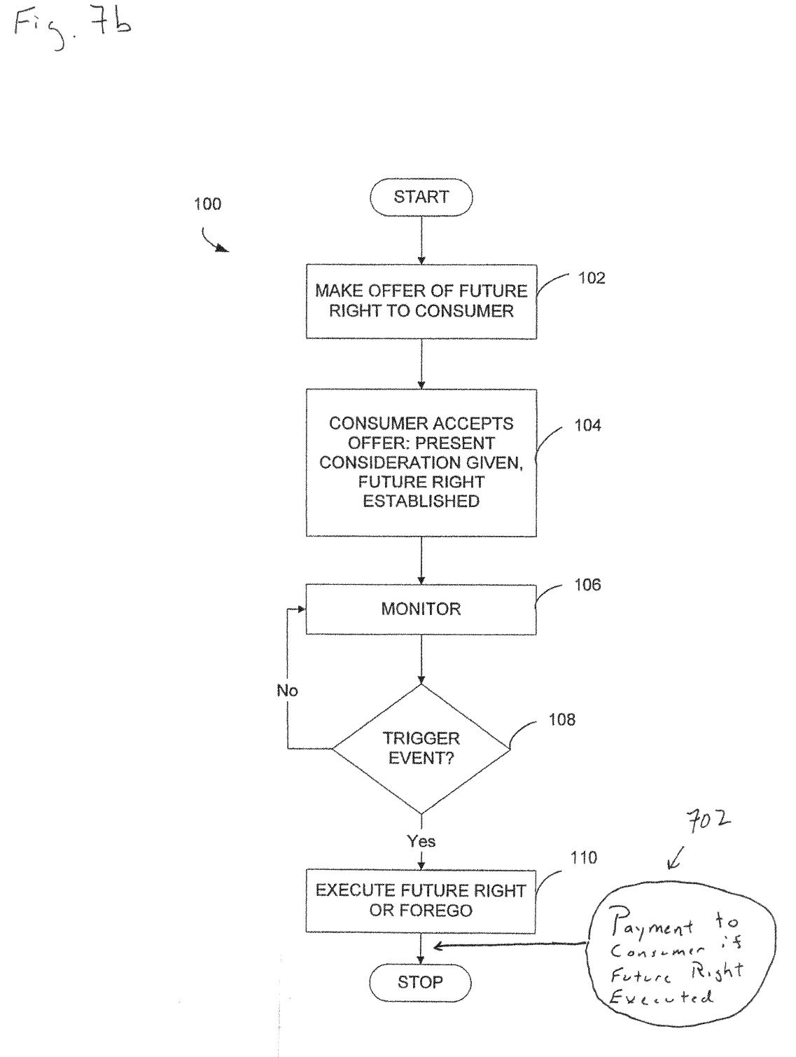

In various embodiments, monitor unit 501 may perform other suitable types of analysis of rate information to determine the occurrence of a trigger event. FIG. 6 shows an exemplary process 600 carried out by monitor unit 501. In the example shown, a borrower has entered into an opt-contract with a lender. In return for consideration, the borrower has agreed to allow the lender to optionally offer to refinance the borrower's mortgage (or other type of loan or debt) in the event that a cost savings or other benefit (e.g. lower monthly payments) becomes available (the trigger event). The decision to offer to refinance may be based on may factors, including factors related to the borrower current mortgage/loan and or loan's available from competing lenders. For example, the lender may consider the type of loan (e.g. fixed or adjustable), term of the loan, related fees, interest rate, etc. similarly, the lender may consider the characteristics of an available refinancing loan. These considerations may be made independently, or a comparison may be made between the borrower's existing loan and potentially available refinancing loans from the lender or competitors.

In step 601, monitor module 501 acquires interest rate information, e.g. using the techniques described above. In step 602, using the acquired interest rate information and, optionally, additional information such as mortgage holder credit information, information related to the property used to secure the mortgage holder's existing mortgage, etc., monitor unit 501 calculates information about the cost of refinancing. In step 603, this cost is compared to the cost of the mortgage holder's existing mortgage. In step 604, if no cost savings (or other benefit) can be provided under the current interest rate conditions, process 600 returns to step 601, and monitoring continues. If a savings can be offered to the mortgage holder, process 600 continues to step 605, and provides an alert that the trigger event has occurred, indicating that the lender may optionally offer to refinance the holder's mortgage.

In some embodiments, the lender's decision to offer or provide refinancing is not based on the interest rate in question, but on other factors. For example, the decision may be based on factors related to the lender, such as the lender's liquidity or other financial factors In various embodiments the decision to offer or provide refinancing may be based on a combination factors related to the interest rate, the mortgage holder, the lender, and/or other considerations.

As will be understood to those skilled in the art, rate monitoring of the type described above may be adapted to various contexts. Although the example above involves a mortgage, similar techniques may be applied to various types of secured or unsecured loans, lines of credit, credit cards etc. Similar monitoring may be applied not only to changes interest rates, but also to changes in property values, government fees, regulatory rules, service fees, etc. Such information may be acquired from publicly available sources or private sources.

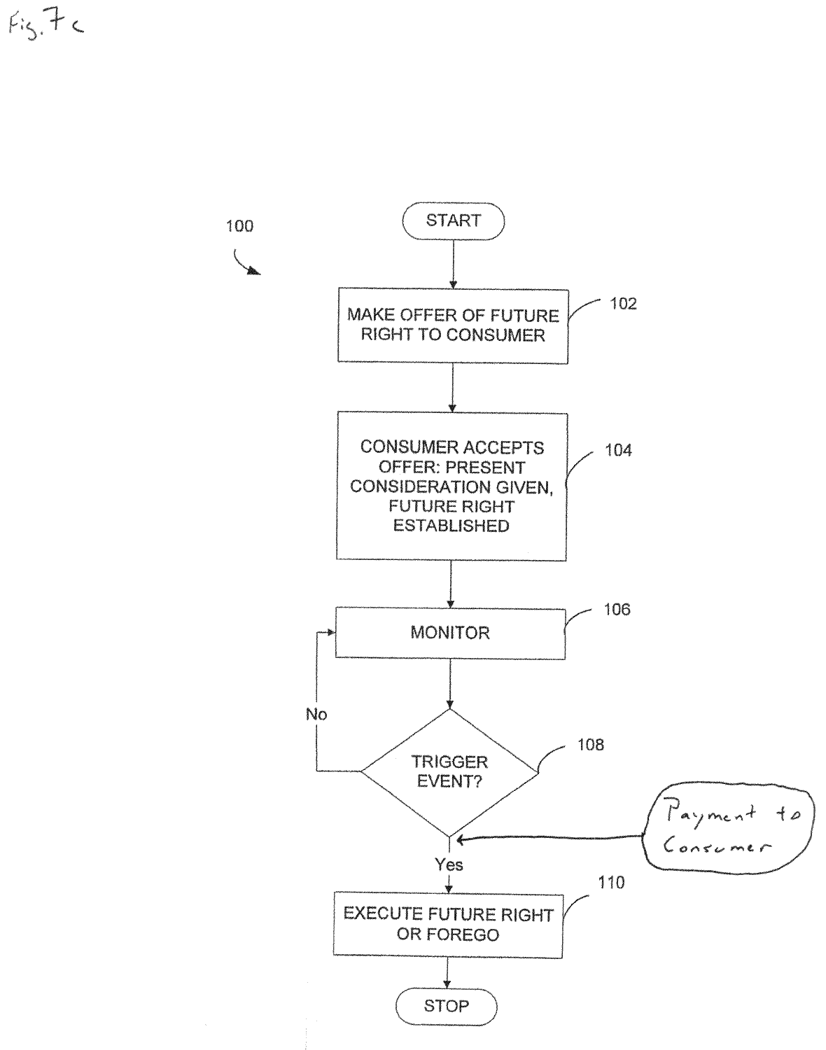

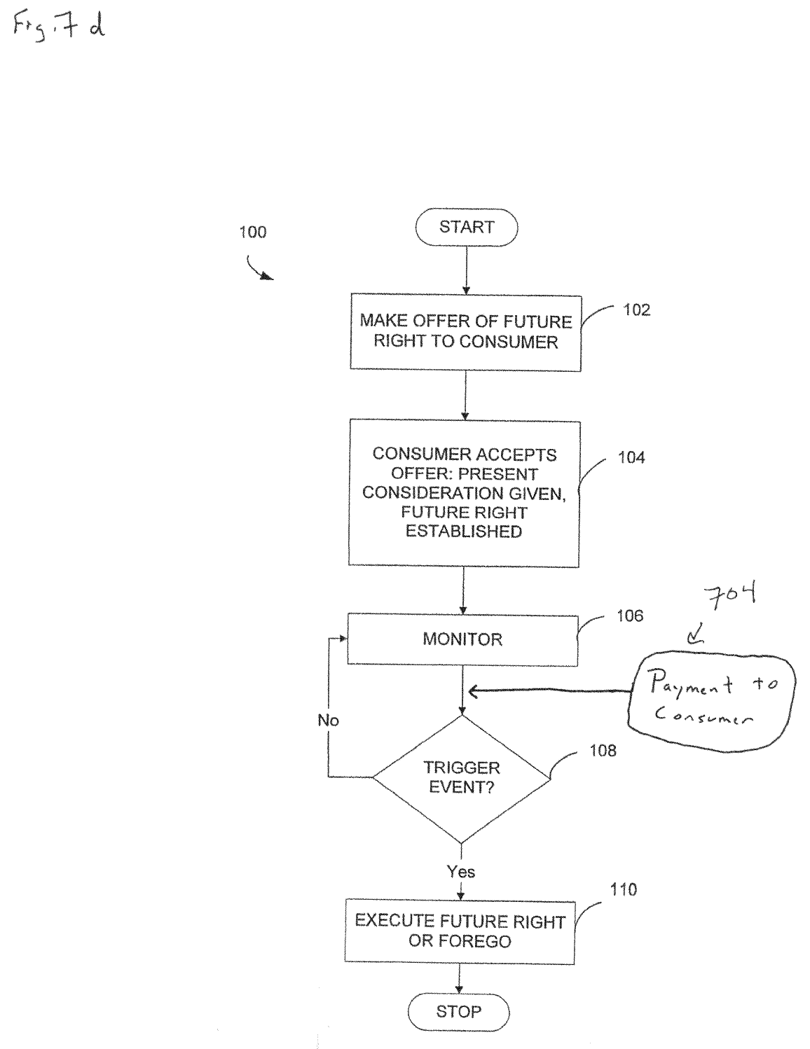

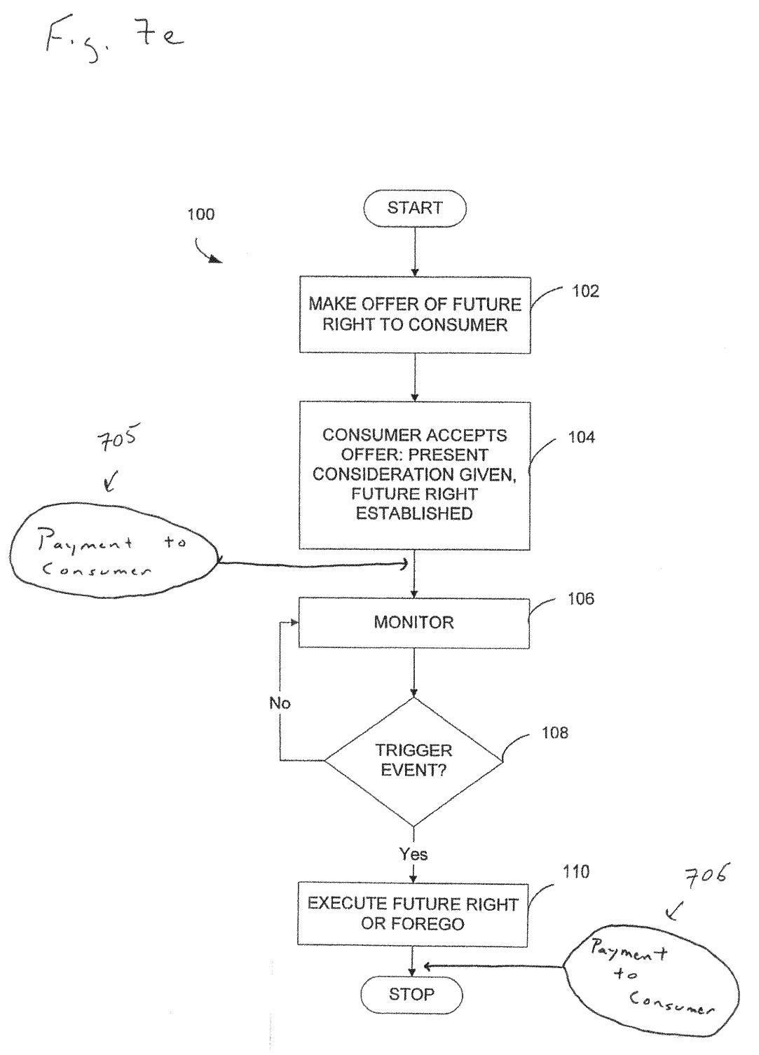

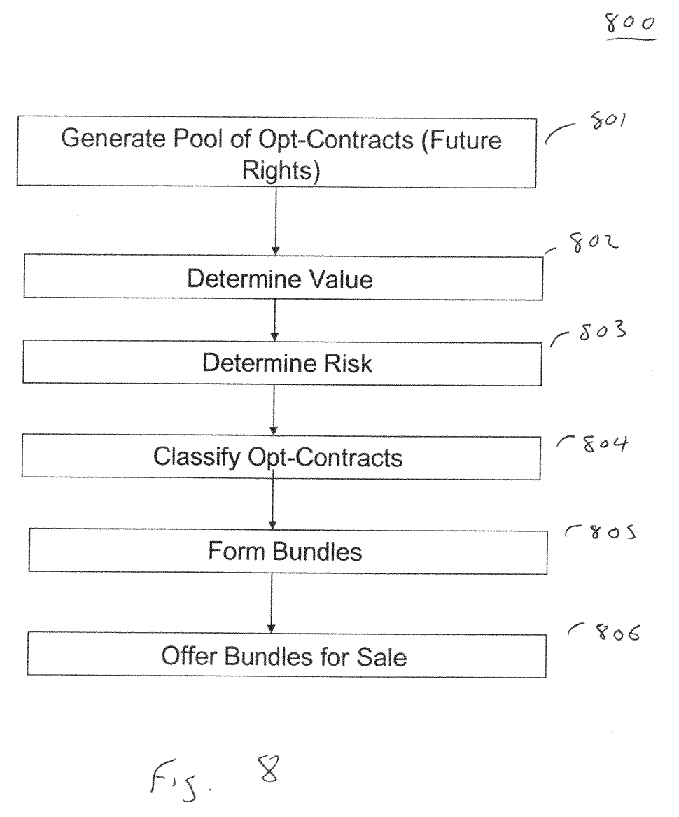

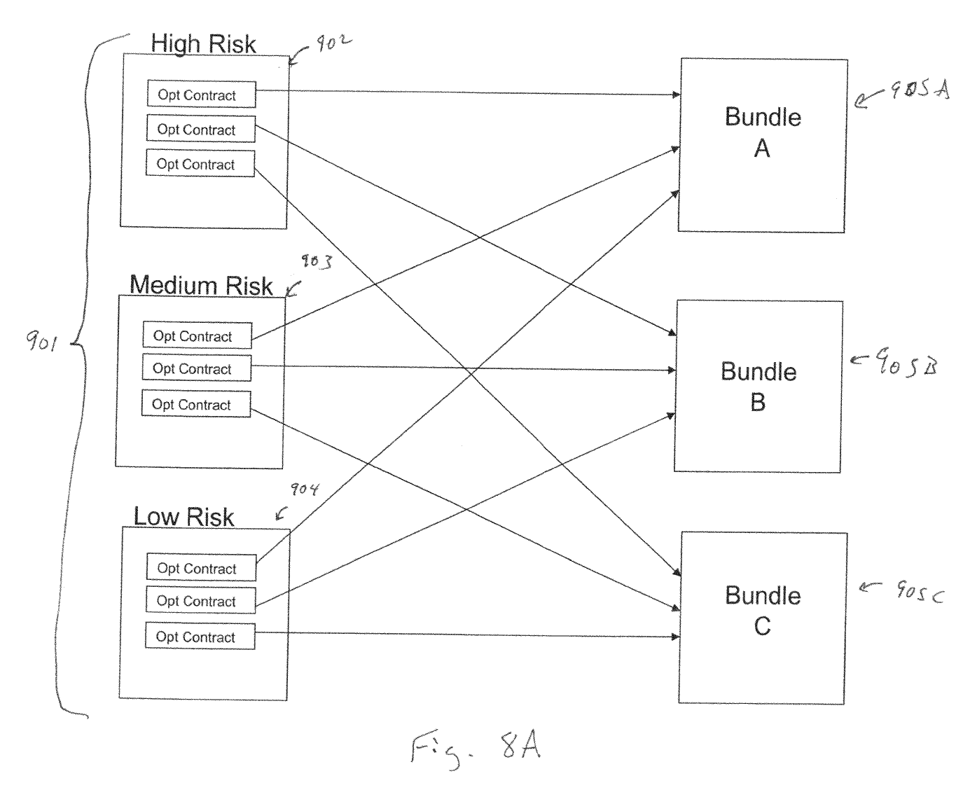

As noted above, in some embodiments, the consideration established at the time an opt-contract future right is created may take the form of a promise of (possibly conditional) future payment, transfer of value, or other action on the part of the opt-contract holder. FIGS. 7A-7E illustrate several exemplary transactions of this type in the context of the method shown in FIG. 1.

In the embodiment shown in FIG. 7A, in step 104 a future right is established in return for consideration in the form of a promise of future payment (or other transfer of value) 701. Payment 701 is made to the consumer after step 104 establishing the future right. The payment may be a one time payment, or may be paid over time in multiple installments. The payment/transfer of value may be a cash payment, a loan (optionally forgivable upon execution of the future right), a discount (e.g discount coupons), merchandise, services, etc.

In FIG. 7B, in step 104 a future right is established in return for consideration in the form of a conditional promise of future payment 702. In this example, payment 702 is made to the consumer only if, in response to a trigger event, the opt-contract holder chooses, in step 10, to execute the future right, If the future right is a right to offer goods or services, payment 702 may further be conditioned on the consumer's acceptance of the offer, For example, the opt-contract may provide for a future right to offer real estate brokerage services in the event that the consumer lists a property for sale. In such a case, payment 702 may be conditioned on the consumer's use of the opt-contract holder's brokerage services.

The embodiment shown in FIG. 7C is similar, but payment 703 is conditioned on the occurrence of the trigger event in step 108. The payment is made prior to the optional execution of the future right in step 10 (e.g. to engender good will prior to an offer of goods or services).

In the embodiment shown in FIG. 7D, payment 704 is made after commencement of monitoring for a trigger event in step 106, but prior to the occurrence of the trigger event in step 108. Payment 704 may be a one time payment or series of payments which may depend for example, on the length of time monitoring occurs, the number of iterations through step 106, etc.

Some embodiments may include combinations of payment schemes of the type described above. For example, in the embodiments shown in FIG. 7E, in step 104 a future right is established in return for consideration in the form payment 705, made at the time of step 104, and of a conditional promise of future payment 706. Payment 706 is made to the consumer only if, in response to a trigger event, the opt-contract holder chooses, in step 110, to execute the future right, and may be further condition, e.g., on the consumers acceptance of an offer of goods/services.

As will be understood by those skilled in the art, any suitable variation on or combination of the payment techniques described above may be used. For example, in some embodiments the future right may be established in return for consideration which takes the form of a promise to make a payment or transfer of value to a third party (e.g a donation to a charity on behalf of the consumer).

As noted above, a secondary market may be created in which groups of opt-contracts are pooled, bundled, and resold. In some embodiments, the price of the bundled opt contract will be determined (at least in part) based on the present value of the bundle's constituent contracts (that statistically will mature over the course of years).

In some embodiments, the opt-contract bundles (or portions thereof) may be auctioned (e.g. using an electronic auction or exchange system). In such embodiments the relevant price is determined based on the auction results. In some embodiments, an initial price at auction or a reserve price (i.e. a minimum price for sale at auction) of the opt-contract bundle may be determined based on the present value of the bundle's constituent contracts or other factors as described herein and/or known in the art.

The present value of an opt-contract may be determined using any of the variety of techniques known in the art. For example, an opt-contract may provide a future right option to broker the sale of homeowner's property at such time that the homeowner decides to sell. The value of such a contract may depend on a number of factors: the likelihood that homeowner will sell, the time at which the homeowner is likely to sell (the trigger event), the likely value of the property at the time of sale, the likelihood that the future right holder will elect to execute the future right, the time value of money, etc. These factors may be estimated based on past performance data, using economic models and projections, or using other suitable techniques. Once the value of each contract in a pool of individual opt-contracts has been determined, the opt-contracts may be grouped for sale as bundles having desired aggregate values.

In some embodiments, other properties of a bundle of opt-contracts may be chosen by selecting appropriate opt-contracts to constitute the bundle. For example, a purchaser of a bundle of opt-contract future rights will likely wish to limit or otherwise manage the risk associated with the bundle. FIGS. 8 and 8A illustrate a process 800 for producing bundles of opt-contracts with a desired value and risk profile.

Referring to FIG. 8, in step 801, a pool of future rights established by opt-contracts is generated. For example, a single holder party may enter into opt-contracts with multiple consumer parties to produce the pool of future rights. Alternatively, transferable future rights established by opt-contracts between various parties may be acquired to produce the pool. In various embodiments, the pool may be generated using other suitable techniques.

In step 802, the values of the opt-contract future rights are determined. These values may be calculated using any suitable technique including any of the techniques mentioned above.

In step 803, risk associated each of the pooled opt-contract future rights is determined. Risk associated with an opt-contract may depend on a number of factors: the accuracy of the estimate its value; the likelihood that a consumer will breach the opt-contract, the likelihood that the associated trigger event may not be properly detected, etc. The severity of risk may be determined using any suitable techniques know in the art. For example, if the estimate of the value of an opt-contract future right depends on the future value of an associated property (as in the case of the home sale brokerage opt contract described above), a risk exists that the future right may be improperly valued if the estimate of the future value of the property is incorrect. This risk may be determined by estimating the accuracy of the prediction of the future value of the property based on, for example, property value statistical data (e.g. price volatility data), economic models/projections, statistical techniques, etc.

In step 804, the opt-contract future rights are classified based on the determined risk and/or value. For example, FIG. 8A illustrates a pool of nine opt contract future rights 901, divided into three risk classifications—high risk 902, medium risk 903, and low risk 904. For simplicity, in the example shown it is assumed that each opt-contract 901 has equal value. Of course, it is to be understood that any number of classifications may be used, and the classifications may depend on multiple factors (e.g. value and risk).

Referring back to FIG. 8, in step 805 the opt-contract future rights in the pool are grouped into bundles based on their classifications to produce bundles with a desired risk and/or value profile. For example, as shown in FIG. 8A, nine opt-contract future rights 901 are grouped into three bundles 905A, 905B, and 905C. Each bundle 905A-C includes one high risk, one medium risk, and one low risk opt-contract future right, to produce a desired risk profile. Of course, in various embodiments, other combinations may be used to produce any suitable risk profile. In various embodiments the bundling may depend on multiple factors (e.g. risk/ value).

Referring back to FIG. 8, in step 805 the bundles are priced based on the various properties of their constituent opt-contract future rights and offered for sale. Alternatively, the bundles may serve as the underlying assets against which securities are offered. The bundles (or related securities) may be bought, sold, and or traded privately or on a public exchange. In some cases, some or all aspects of the sale/exchange of the bundles/securities may be automated using a compute or computer network. Such a network may work in concert with an opt-contract registry system of the type described above.

Although the examples above detail the management of the risk and value profile of a bundle of opt-contracts, other factors may be used in determining the constituency of the bundle. For example, bundles may be provided which include opt-contract future rights to offer or provide goods are services across a variety of industries/products. For example, a bundle may include opt-contract future rights related to real estate brokerage, mortgages, credit cards, insurance, collectables, motor vehicles, legal services, appliance repair, etc. This scheme provides for industry sector diversification, and protects the value of the bundle in the event of a steep downturn in a single sector (e.g. real estate). Similarly, a bundle of opt-contract future rights related to, for example, real estate may be constructed such that the constituent opt-contracts are related to real properties in a variety of geographic locations. The scheme provides for geographic diversification, and protects the value of the bundle in the event of, for example, a steep downturn in property sales in a single locale.

Although several examples have been provided, as will be understood by one skilled in the art, any of a multitude of combinations of factors may be used to construct bundles having desired properties by proper classification and choice of the bundle's constituent opt-contract future rights.

For example, several examples have been provided related to mortgages provided by lenders. It is to be understood that the techniques described herein may be equally well applied to other types of loans or credit debt relationships be they unsecured, secured by real property, secured by other types of tangible property, secured by intangible property, secured by combinations thereof, or otherwise. The “lender” may, for example, be a loan originator, servicer, broker, bank, financial institution, investor, etc., and may include multiple parties.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. As used herein, the terms “includes” and “including” mean without limitation. It is intended by the following claims to claim any and all modifications and variations that fall within the true scope of the inventive concepts.

What is claimed is:

1. A method comprising:
identifying a first party and a second party;
establishing consideration to the first party; and
generating an opt-contract establishing a conditional future right option in the second party wherein the future right is an option to offer or to provide to the first party goods or services in response to a trigger event;
wherein at least a portion of one or more of the above steps is carried out by a computer.

2. The method of claim 1, further comprising monitoring for an occurrence of the trigger event.

3. The method of claim 1, wherein the establishing consideration is performed coincidentally with the generating an opt contract.

4. The method of claim 1, wherein the establishing consideration to the first party comprises establishing a promise by the second party to transfer value to the first party.

5. The method of claim 4, wherein the promise by the second party to transfer value to the first party is a conditional promise to transfer value in response to the trigger event.

6. The method of claim 1, wherein the establishing consideration to the first party comprises establishing a promise by the second party to transfer value to a third party on behalf of the first party.

7. The method of claim 6, wherein the third party is a charitable organization and the transfer of value comprises a donation to said charitable organization.

8. The method of claim 1, wherein the establishing consideration comprises transferring value from the second party to the first party prior to the trigger event.

9. The method of claim 1, wherein the establishing consideration comprises transferring value from the second party to the first party subsequent to or coincidentally with the trigger event.

10. The method of claim 1, wherein the conditional future right option to offer or to provide to the first party goods or services in response to a trigger event is a transferable right.

11. The method of claim 10, wherein the conditional future right option is related to a property and transferrable in response to changes of ownership of the property.

12. The method of claim 1, wherein the goods and services are related to a property controlled by the first party, and the conditional future right option runs with the control of the property.

13. The method of claim 10, further comprising transferring the conditional future right option from the second party to a third party in return for valuable consideration.

14. The method of claim 13, further comprising, prior to transferring the conditional future right, calculating the present value of the conditional future right.

15. The method of claim 1, wherein the conditional future right option in the second party comprises a right to engage a third party to offer or to provide to the first party goods or services in response to a trigger event.

16. The method of claim 1, wherein
the trigger event comprises the identification by the first party of a property or class of properties of interest, and
the future right is an option to offer or to provide to the first party goods or services related to the property or class of property of interest.

17. The method of claim 16, wherein the goods or services related to the property or class of property of interest comprise services related to the acquisition of rights related to at least a portion of the property or class of property of interest.

18. The method of claim 17, wherein the acquisition of rights related to at least a portion of the property or class of property of interest comprises an acquisition of rights by the first party.

19. The method of claim 17, wherein the acquisition of rights related to at least a portion of the property or class of property of interest comprises an acquisition of rights by a third party.

20. The method of claim 1, further comprising:
in response to the trigger event, acquiring information related to an offer by a third party to provide goods and services to the first party; and
determining, based on the information related to the offer by the third party, to exercise the second party's option to offer or to provide to the first party goods or services.

21. The method of claim 20, wherein
the information related to the offer by the third party comprises a cost information, and
the determining, based on the information related to the offer by the third party, to exercise the second party's option to offer or to provide to the first party goods or services comprises comparing the cost information to a threshold value.

22. The method of claim 1, wherein the option to offer or to provide to the first party with goods or services in response to a trigger event comprises a right of first refusal.

23. The method of claim 1, wherein the trigger event is related to a change in an available interest rate.

24. The method of claim 23, wherein the interest rate is related to a publicized interest rate.

25. The method of claim 23, wherein the first party is subject to a loan with a corresponding loan interest rate, and the occurrence of the trigger event is based on a change in the relationship between the loan interest rate and the available interest rate.

26. The method of claim 25, wherein the available interest rate is related to at least one chosen from the list of, the U.S. Prime Rate, the London Interbank Offered Rate, Mumbai Inter-Bank Offer Rate, Tokyo Interbank Offered Rate, Euro Interbank Offered Rate, a U.S. Treasury rate.

27. The method of claim 17, wherein the trigger event is related to a change in a currency exchange rate.

28. The method of claim 1, wherein the defined sets of goods and services are related to a property.

29. The method of claim 28, wherein the property comprises tangible property.

30. The method of claim 29, wherein the property comprises real property.

31 The method of claim 28, wherein the property comprises intangible property.

32. The method of claim 28, wherein the property is at least partially controlled by the first party.

33. A method comprising the steps of:
generating multiple opt-contracts for a holder, wherein generating each opt-contract comprises:
identifying a first party
establishing consideration to the first party; and
generating an opt-contract establishing a conditional, transferable, future right option in the holder wherein the future right is an option to offer or to provide to the first party goods or services in response to a trigger event;
determining information indicative of a characteristic of each of the opt contracts;
forming one or more bundles of opt-contracts from the multiple opt-contracts based on the information indicative of the characteristic of each of the opt contracts; and
selling one or more of the bundles to a buyer party.

34. The method of claim 33, wherein determining information indicative of a characteristic of each of the opt contracts comprises determining information indicative of the value of one or more of the opt contracts.

35. The method of claim 33, wherein selling one or more of the bundles to a buyer party comprises auctioning the one or more of the bundles.

36. The method of claim 34, wherein determining information indicative of a characteristic of each of the opt contracts comprises determining information indicative of risk associated with one or more of the multiple opt-contracts.

37. The method of claim 36, wherein the forming one or more bundles comprises forming one or more bundles of opt-contracts from the multiple opt-contracts based on information indicative of the value of one or more the multiple opt-contracts and on the information indicative of risk associated with one or more of the multiple opt-contracts.

38. The method of claim 33, further comprising, for at least one of the multiple opt contracts. monitoring for the occurrence of the trigger event.

39. The method of claim 33, wherein, for at least one of the multiple op-contracts, the goods and services are goods and services related to a property.

40. The method of claim 39, wherein the property comprises tangible property.

41. The method of claim 40, wherein the property comprises real property.

42. The method of claim 39, wherein the property comprises intangible property.

43. The method of claim 39, wherein the property is at least partially controlled by the first party.

44. A method comprising:
identifying a first party and a second party;
establishing consideration to the first party; and
generating an opt-contract establishing a conditional future right option in the second party wherein the future right is an option to contact the first party in response to a trigger event;
wherein at least a portion of one or more of the above steps is carried out by a computer.

45 The method of claim 44, further comprising monitoring for an occurrence of the trigger event.

46. The method of claim 45, wherein the option to contact first party comprises the option to allow a third party to contact the first party.

47. The method of claim 44, further comprising:
generating a list of parties which may not be contacted by the second party; and
in response to the trigger event, at the second party's option, exempting the first party from said list.

48. The method of claim 44, wherein conditional future right option is a transferable option.

49. The method of claim 447 wherein the option to contact the first party is an option to contact the first party during a defined period of time.

50. The method of claim 44, wherein the option to contact the first party in response to the trigger event comprises an option to offer goods or services.

51. The method of claim 50, wherein the goods and services are related to a property.

52. The method of claim 51, wherein the property comprises real property.

53. The method of claim 44, wherein the option to contact the first party in response to the trigger event comprises an option to contact the first party over a communication channel chosen from the list consisting of: postal mail, telephone, facsimile, e-mail, electronic messaging, text messaging, videoconference, and personal visitation.

54. The method of claim 44, further comprising acquiring contact information from the first party.

55. A method comprising the steps of:
generating multiple opt-contracts for a holder, wherein generating each opt-contract comprises:
identifying a first party and a second party;
establishing consideration to the first party; and
generating an opt-contract establishing a conditional future right option in the second party wherein the future right is an option to contact the first party in response to a trigger event;
determining information indicative of a characteristic of each of the opt contracts;
forming one or more bundles of opt-contracts from the multiple opt-contracts based on the information indicative of the characteristic of each of the opt contracts; and
selling one or more of the bundles to a buyer party.

56. The method of claim 55, wherein determining information indicative of a characteristic of each of the opt contracts comprises determining information indicative of the value of one or more of the opt contracts.
